(19) United States
(12) Patent Application Publication
(10) Pub. No.: US 2025/0196708 A1
(43) Pub. Date: Jun. 19, 2025

(54) METHOD OF CHARGING BATTERY OF VEHICLE USING BATTERY STATUS DIAGNOSIS AND APPARATUS FOR PERFORMING THE SAME

(71) Applicants: Hyundai Motor Company, Seoul (KR); Kia Corporation, Seoul (KR)

(72) Inventor: Hae-Sik Kim, Hwaseong-si (KR)

(21) Appl. No.: 18/817,573

(22) Filed: Aug. 28, 2024

(30) Foreign Application Priority Data
Dec. 18, 2023 (KR) 10-2023-0184191

(51) Int. Cl. B60L 58/12; B60L 53/66; B60L 55/00; B60L 58/16; H02J 7/00

(52) U.S. Cl. CPC B60L 58/12; B60L 53/665; B60L 55/00; B60L 58/16; H02J 7/0048; H02J 7/005; B60L 2210/30

(57) ABSTRACT

An embodiment method of charging a battery of a vehicle using battery state diagnosis includes acquiring, by a charging controller, battery status information from the battery, checking, by the charging controller, battery status accuracy using the battery status information, according to the check result, determining, by the charging controller, whether to sell power stored in the vehicle, and according to the determination result, discharging, by the charging controller, the power stored in the vehicle to a charging station or performing charging by receiving power from the charging station.

### CROSS-REFERENCE TO RELATED APPLICATIONS

This application claims the benefit of Korean Patent Application No. 10-2023-0184191, filed on Dec. 18, 2023, which application is hereby incorporated herein by reference in its entirety.

### TECHNICAL FIELD

Exemplary embodiments of the present disclosure relate to a charging technology and, more specifically, to a method of charging a battery of a vehicle using battery status diagnosis and an apparatus for performing such a method.

### BACKGROUND

Generally, layered batteries such as lithium cobalt oxide (LCO) batteries and lithium nickel manganese cobalt oxide (NCM) batteries are applied to vehicle batteries. In the case of vehicles to which such layered batteries are applied, it is possible to estimate a state of charge (SOC) using an open circuit voltage (OCV) value according to the SOC.

However, in the case of vehicles to which lithium iron phosphate (LFP) batteries are applied, there is a problem in that it is difficult to estimate an amount of the SOC using an OCV because a voltage variation in a period of SOC 25% to 99% is small.

In vehicles to which the LFP batteries are applied, an SOC is estimated through current integration. However, when a flat period (SOC 25% to 99%) is repeatedly used, an error increases so that it is impossible to accurately estimate the SOC.

Therefore, these vehicles are recommended to discharge the LFP batteries to SOC 20% or less every two weeks or ten times of discharging and impose performance restrictions such as fast charging limitations and output limitations when the flat period is used continuously.

However, it is not easy for a driver to generate a discharging situation of SOC 20% or less due to anxiety of a remaining travelable distance or a mileage. In addition, there is a problem in that it is difficult to repeat a corresponding driving pattern according to a driving pattern. In other words, in the case of the vehicles to which the LFP batteries are applied, it is recommended to periodically perform fully charging or discharging of SOC 25% or less. Therefore, a recommendation to perform discharging of SOC 25% or less is difficult for the driver to implement for reasons such as anxiety of the remaining mileage.

In addition, when accuracy of the SOC and a state of health (SOH) is low, the following problems occur.

\textcircled{1} A fast charging current varies according to the SOC, and there is a problem in that fast charging may not be performed when the SOC is uncertain. \textcircled{2} It is impossible to measure an exact remaining capacity due to an unclear SOC so that a remaining mileage may be inconsistent with an actual remaining distance to travel. \textcircled{3} There is a battery guaranteed output according to the SOC so that a battery output may be limited in case of an uncertain SOC. \textcircled{4} Problems such as rapid decrease in lifetime of the battery may occur through measurement of battery degradation. \textcircled{5} Accurate calculation of an expected charging time may not be possible.

### SUMMARY

An embodiment of the present disclosure is directed to providing a method of charging a battery of a vehicle using battery status diagnosis.

Another embodiment of the present disclosure is directed to providing a charging method that may improve battery performance by calculating an exact amount of a state of charge (SOC) without affecting a usage pattern of a driver.

Other objects and advantages of embodiments of the present disclosure can be understood by the following description and become apparent with reference to the embodiments of the present disclosure. Also, it is obvious to those skilled in the art to which the present disclosure pertains that the objects and advantages of embodiments of the present disclosure can be realized by the means as claimed and combinations thereof.

In accordance with an embodiment of the present disclosure, there is provided a method of charging a battery of a vehicle using battery status diagnosis, which includes acquiring, by a charging controller, battery status information from the battery, checking, by the charging controller, battery status accuracy using the battery status information, according to the check result, determining, by the charging controller, whether to sell power stored in the vehicle, and according to the determination result, discharging, by the charging controller, the power stored in the vehicle to a charging station or performing charging by receiving power from the charging station.

In this case, the checking of the battery status accuracy may include reading, by the charging controller, the battery status information when the SOC enters below a predetermined inflection point during discharging, and according to the reading result, calculating, by the charging controller, the battery status accuracy.

In addition, the performing of the charging may include calculating, by the charging controller, a current battery SOC and a current battery state of health (SOH).

In addition, the current battery SOC may be calculated using a current integration during charging when the SOC during discharging of the battery is below a predetermined inflection point and after a vehicle to grid (V2G) function of supplying power to a power grid is executed.

In addition, the current battery SOH may be calculated using a total SOC when charging begins when the SOC during discharging of the battery is in an area below a predetermined inflection point and the battery is fully charged.

In addition, the checking of the battery status accuracy may include checking whether the vehicle and the charging station are equipped with two-way chargers supporting the V2G function of supplying power to a power grid, and according to the check result of whether the two-way chargers are provided, discharging the power stored in the vehicle to the charging station or performing charging by receiving the power from the charging station.

In addition, the checking of the battery status accuracy may include, according to the check result of whether the two-way chargers are provided, when any one of the vehicle and the charging station is not equipped with the two-way charger, receiving, by the charging controller, the power from the charging station to perform charging.

In addition, the determining of whether to sell power may include checking, by the charging controller, whether a driver consents to use the V2G function, and according to the check result of whether the vehicle driver consents to use the V2G function, determining whether to sell the power.

In addition, the battery status information may include at least one of a final date and time in which the battery is finally fully charged, a number of times the battery is partially charged after the battery is finally fully charged, a final discharging time point indicating a time point when the battery is finally discharged below an inflection point, and a number of charging times of the battery after a final discharging indicating charging times after the battery is finally discharged below the inflection point.

In addition, the battery may include a lithium iron phosphate (LFP) battery.

In addition, the predetermined inflection point may refer to a position where the SOC becomes 25% on an SOC-OCV curve.

In addition, the full charging may refer to a position where the SOC becomes 100% on the SOC-OCV curve.

In accordance with an embodiment of the present disclosure, there is provided an apparatus of charging a battery of a vehicle using battery state diagnosis including an input part configured to input a command of a driver, a charging controller configured to transmit and receive signals to and from the components of the vehicle and control the components, a battery for a power source to move the vehicle and including a battery management system (BMS), a charger including a two-way charger configured to convert an alternating current (AC) into a direct current (DC) to charge the battery or vice versa, and a communication part configured to connect the charging controller to a communication network and/or the charger.

The charging controller may include a collection module configured to acquire battery status information, a determination module configured to check battery status accuracy using the acquired battery status information and determine whether to sell power and perform charging, and a control module configured to control the charger for selling or charging power.

The collection module may be configured to acquire input information directly input by the driver through the input part or acquire battery status information from the BMS.

The determination module may be configured to check accuracy of a current battery status using the battery status information acquired from the collection module, determine whether to sell the power stored in the vehicle, and perform charging.

The control module may be configured to control the charger for power sales or charging.

The charging controller is configured to acquire battery status information from the battery, check battery status accuracy using the battery status information, determine whether to sell power stored in the vehicle according to the check result of the battery status accuracy, and discharge the power stored in the vehicle to a charging station or perform charging by receiving power from the charging station according to the determination result of whether to sell the power.

The charging controller may be configured to calculate a current battery SOC and a current battery SOH.

The current battery SOC may be calculated using a current integration during charging when the SOC during discharging of the battery is below a predetermined inflection point and after a V2G function of supplying power to a power grid is executed, wherein the current battery SOH may be calculated using a total SOC when charging begins when the SOC during discharging of the battery is in an area below a predetermined inflection point and the battery is fully charged.

### BRIEF DESCRIPTION OF THE DRAWINGS

FIG. 1 is a conceptual diagram illustrating a charging system according to an exemplary embodiment of the present disclosure.

FIG. 2 is a detailed configurational block diagram illustrating a charging apparatus provided in a vehicle in FIG. 1.

FIG. 3 is a detailed configurational block diagram illustrating a charging controller shown in FIG. 2.

FIG. 4 is a conceptual diagram of charging using a vehicle-to-grid (V2G) according to an exemplary embodiment of the present disclosure.

FIG. 5 is a flowchart illustrating a process of charging a vehicle according to an exemplary embodiment of the present disclosure.

FIG. 6 is a graph showing a relationship between a state of charge (SOC) and an open-circuit voltage (OCV) of a lithium-ion battery and a lithium iron phosphate (LFP) battery.

FIG. 7 is a graph showing an error cause of the SOC during use.

### DETAILED DESCRIPTION OF ILLUSTRATIVE EMBODIMENTS

The above and other objectives, features, and advantages of embodiments of the present disclosure will be described in detail with reference to the accompanying drawings, and therefore, the technical spirit of the present disclosure can be easily implemented by those skilled in the art. In the following description of embodiments of the present disclosure, when a detailed description of the known related art is determined to obscure the gist of the present disclosure, the detailed description thereof will be omitted.

Hereinafter, exemplary embodiments of the present disclosure will be described in detail with reference to the accompanying drawings. In the drawing, the same reference numeral refers to the same or similar component.

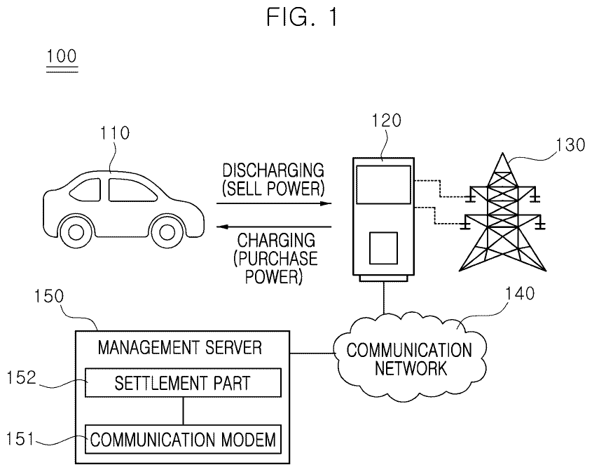

FIG. 1 is a conceptual diagram illustrating a charging system 100 according to an exemplary embodiment of the present disclosure. Referring to FIG. 1, the charging system 100 may include a vehicle 110, a charging station 120, a power grid 130, a communication network 140, and a management server 150.

The vehicle 110 may sell power stored in a battery to the charging station 120 or purchase power from the charging station 120.

The charging station 120 may be connected to the power grid 130 and perform a function of receiving power from the vehicle 110 and supplying the power to the power grid 130 or receiving power from the power grid 130 and supplying the power to the vehicle 110. In addition, the charging station 120 may be connected to the management server 150 through the communication network 140. To this end, the charging station 120 may include electric vehicle supply equipment (EVSE), a communication modem, a microprocessor, a microcomputer, and a communication circuit. Of course, the EVSE may be equipped with a one-way charger or a two-way charger.

The charging station 120 may perform a function of calculating an amount of power supplied to the vehicle 110 or an amount of power supplied from the vehicle 110 and transmitting the calculated amount of power to the management server 150.

The power grid 130 may be a network scheme that supplies power to various consumers from a power plant through a distribution station. The power grid 130 may include a smart grid and a micro grid.

The communication network 140 may refer to a connection structure that allows information exchange between nodes such as a plurality of terminals and a plurality of servers and may be a public switched telephone network (PSTN), a public switched data network (PSDN), an integrated services digital network (ISDN), a broadband ISDN, a local area communication network (LAN), a metropolitan area network (MAN), and a wide LAN (WLAN).

However, the present disclosure is not limited thereto, and the communication network 140 may be a code division multiple access (CDMA), a wideband code division multiple access (WCDMA), a wireless broadband (Wibro), a wireless fidelity (WiFi), a digital living network alliance (DLNA), Zigbee, Z-wave, a high speed downlink packet access (HSDPA) network, Bluetooth, a radio frequency identification (RFID), an infrared data association (IrDA), an ultra-wide band, a wireless universal serial bus (USB), a near field communication (NFC) network, a satellite broadcasting network, an analog broadcasting network, and a digital multimedia broadcasting (DMB) network, which are wireless communication networks.

Alternatively, the communication network 140 may be a combination of these wired communication networks and wireless communication networks. In addition, the communication network 140 may include a power communication network. The power communication network may refer to a network constructed for communication by transmitting data signals through the existing power lines using a power line communication (PLC) technology.

The power lines may include high-voltage power lines (about 22.9 kV) and/or low-voltage power lines (about 110 V to 220 V). In addition, the power communication network may include a repeater, a power communication modem, and a transformer. A master modem performs a function of connecting the power communication network to the existing communication network.

The management server 150 may receive power amount information calculated on the basis of an amount of power supplied from the vehicle 110, calculate a power selling amount, and perform a function of accumulating the power selling amount. In addition, the management server 150 may perform a function of calculating a power charging amount by receiving the power amount information calculated on the basis of the amount of power supplied to the vehicle 110.

To this end, the management server 150 may include a communication modem 151 connected to the communication network 140 and a settlement part 152 which settles a current amount using the power selling amount and charging amount. Of course, the management server 150 may include a database which stores a vehicle number, driver information, driver-owned communication terminal information, and charging station information.

Of course, it is also possible to perform the functions performed by the management server 150 in the charging station 120 and transmit only the final result information to the management server 150. That is, the functions such as calculating the power selling amount and amount settlement may be performed at the charging station 120, and only the final results are transmitted to the management server 150.

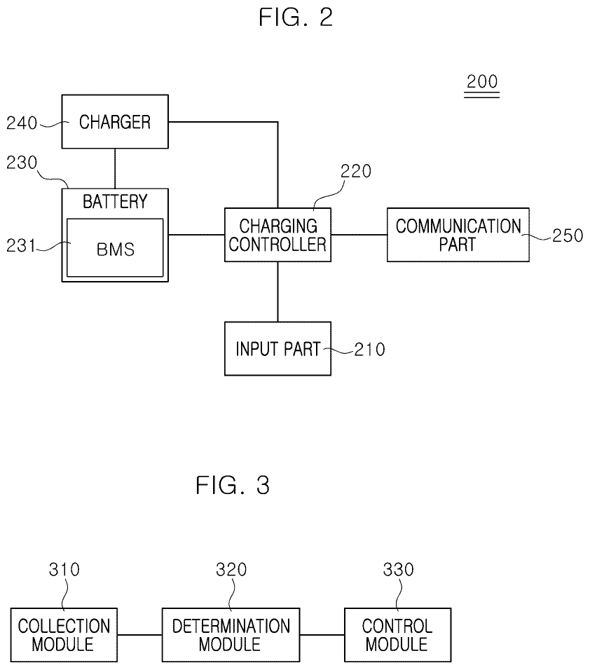

FIG. 2 is a detailed configurational block diagram illustrating a charging apparatus 200 provided in the vehicle 110 shown in FIG. 1. Referring to FIG. 2, the charging apparatus 200 may include an input part 210, a charging controller 220, a battery 230, a charger 240, and a communication part 250.

The input part 210 may perform a function of inputting a command of a driver. In this case, the command may be a touch, voice, and/or a motion. Thus, the input part 210 may be an operation key, a touch screen, a microphone, or a combination thereof. The touch screen may also perform a display function.

Thus, the input part 210 may include navigation, a cluster, and a communication terminal. The navigation may be audio visual navigation (AVN). The communication terminal may be a smart phone, a laptop computer, and a note pad and may be connected to the vehicle through the communication part 250.

The charging controller 220 may perform a function of transmitting and receiving signals to and from the components of the vehicle and controlling the components. To this end, the charging controller 220 may include a microprocessor, a microcomputer, a communication circuit, and a memory.

The memory may be a memory provided in a microprocessor or a microcomputer or may be a separate memory. Thus, the memory may include a non-volatile memory such as a solid state disk (SSD), a hard disk drive, a flash memory, an electrically erasable programmable read-only memory (EEPROM), a static random access memory (SRAM), a ferro-electric RAM (FRAM), a phase-change RAM (PRAM), or a magnetic RAM (MRAM) and/or a volatile memory such as a dynamic RAM (DRAM), a synchronous RAM (SDRAM), a double data rate-SDRAM (DDR-SDRAM), or a combination thereof.

The battery 230 may formed of lithium iron phosphate (LFP) battery cells (not shown) in series and/or parallel. In general, the battery may be a battery used as a power source to move an electric vehicle and provide a high voltage of 100 V or more. However, the present disclosure is not limited thereto, and a low-voltage battery is also possible.

In addition, the battery 230 may include a battery management system (BMS) 231. The BMS 231 may serve to optimize vehicle battery management to increase energy efficiency and extend lifetime. The BMS 231 may monitor a battery voltage, a battery current, and a battery temperature in real time and use the monitored voltage, current, and temperature to generate battery status information. The BMS 231 may use the battery status information to prevent excessive charging and discharging in advance, thereby increasing battery safety and battery reliability.

The battery status information may include an SOC, an SOH, a depth of discharging (DOD), and a state of function (SOF).

The charger 240 may be a two-way charger performing a function of converting an alternating current (AC) into a direct current (DC) to charge the battery 230 inside the vehicle 110 or converting power of the battery 230 from DC to AC to provide the converted power to the power grid 130 via the charging station 120.

To this end, the charger 240 may include an input filter for removing a noise from AC power that is input power, a DC-DC converter for stably supplying power to the battery 230, and a full-bridge type inverter. A phase shift full-bridge (PSFB) type, an inductor inductor capacitor (LLC) resonant type, or a capacitor inductor capacitor (CLLC) resonant type converter may be used as the DC-DC converter.

The charger 240 may be connected to a connector (not shown), and the connector (not shown) may be connected to the charging station 120 in an outlet-inlet manner.

The communication part 250 may perform a function of connecting to the communication network 140 and/or the charger 240. Therefore, the communication part 250 may be connected to the management server 150 and a communication terminal (not shown) to receive or transmit data. The communication terminal may be a mobile phone, a smart phone, a laptop computer, or a note pad.

FIG. 3 is a detailed configurational block diagram illustrating the charging controller 220 shown in FIG. 2. Referring to FIG. 3, the charging controller 220 may include a collection module 310 configured to acquire the battery status information, a determination module 320 configured to check battery status accuracy using the acquired battery status information and determine whether to sell power and perform charging, and a control module 330 configured to control the charger 240 for selling power or charging.

The collection module 310 may acquire input information directly input by the driver through the input part 210 or may acquire system input information generated from sensors constituting the system. In particular, the collection module 310 may acquire the battery status information from the BMS 231. When the battery is finally fully charged (e.g., about 100%), the battery status information may include the final date and time at which the battery is finally fully charged (e.g., approximately 100%), the number of times the battery is partially charged (e.g., 100% or less) after the battery is finally fully charged, a final discharging time point indicating a time point when the battery is finally discharged below an inflection point (e.g., about 25%), and the number of charging times of the battery after the battery is finally discharged below the inflection point.

To this end, the collection module 310 may include a microprocessor, a microcomputer, and a communication circuit.

The determination module 320 checks accuracy of a current battery status using the battery status information acquired from the collection module 310, determines whether to sell the power stored in the vehicle, and performs charging. The determination module 320 may be a unit for processing at least one function or operation and may be implemented in software and/or hardware. The hardware may be implemented with an application specific integrated circuit (ASIC) designed to perform the above functions, a digital signal processor (DSP), a programmable logic device (PLD), a field programmable gate array (FPGA), a processor, a microprocessor, another electronic unit, or a combination thereof.

Software implementation may include a software configuration component (element), an object-oriented software configuration component, a class configuration component and a work configuration component, a process, a function, an attribute, a procedure, a subroutine, a segment of a program code, a driver, firmware, a microcode, data, a database, a data structure, a table, an array, and a variable. The software and the data may be stored in a memory and executed by a processor. The memory and the processor may employ various parts well known to those skilled in the art.

The control module 330 may perform a function of controlling the charger 240 for power sales or charging. To this end, the control module 330 may include a switching element, a signal modulation control circuit, and an integrated circuit (IC). Semiconductor switching elements such as a field effect transistor (FET), a metal oxide semiconductor FET (MOSFET), an insulated gate bipolar mode transistor (IGBT), a power rectifier diode, a thyristor, a gate turn-off (GTO) thyristor, a triode for alternating current (TRIAC), a silicon controlled rectifier (SCR), and an IC circuit may be used as the switching element. Signal modulation may generally be pulse width modulation (PWM).

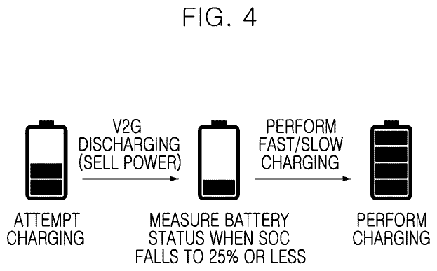

FIG. 4 is a conceptual diagram of charging using a vehicle-to-grid (V2G) according to one embodiment of the present disclosure. Referring to FIG. 4, when the vehicle 110 attempts to charge, a discharging process for selling power is performed. When the SOC during discharging falls to 25% or less, the charging controller 220 of the vehicle 110 measures the battery status and performs a fast or slow charging process.

\textcircled{1} In the case of an LFP battery, when the SOC is present in a period ranging from SOC 25% to 99%, the SOC cannot be accurately measured using an OCV.

\textcircled{2} When the LFP battery is fully charged, the SOC is defined as 100%, and the remaining SOC is calculated through a current integration.

\textcircled{3} The LFP battery has a large voltage variation when discharged to SOC 25% or less, and thus the SOC may be calculated. In this case, the SOC may be calculated by integrating a current during charging.

\textcircled{4} A calculation of a SOH according to \textcircled{1} to \textcircled{3} may be possible when the battery is discharged to SOC 25% or less and charged to SOC 100%.

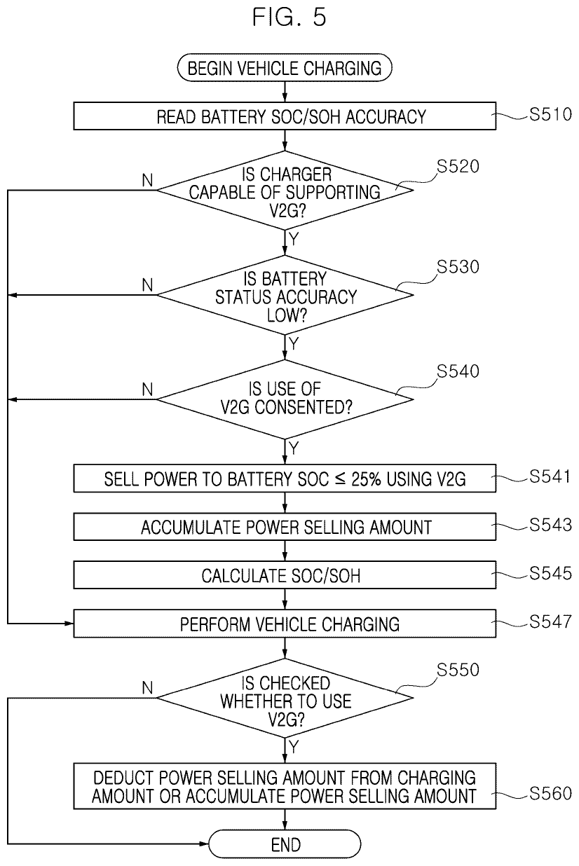

FIG. 5 is a flowchart illustrating a process of charging a vehicle according to one embodiment of the present disclosure. Referring to FIG. 5, when charging of the vehicle 110 begins, the charging controller 220 may read the battery status accuracy of the battery 230 (S510). Read items may include finally full charged date and time of the battery, the number of times of partial charging after the finally full charge, a time point of final discharging, and the number of times of charging after the final discharging. These are described in an easy-to-understand manner as follows.

\textcircled{1} The final date and time for charging the battery to SOC 100%.

\textcircled{2} The number of times of partial charging (i.e., SOC 100% or less) after the battery is finally charged to SOC 100%.

\textcircled{3} A final discharging time of the battery to SOC 25% or less.

\textcircled{4} The number of times of charging after the battery is finally discharged to SOC 25% or less.

Meanwhile, the battery status accuracy is described in an easy-to-understand manner as follows.

i) Based on the date and time of the battery being finally charged to SOC 100%, accuracy of the SOC of the battery is evaluated according to whether a certain period of time elapses after the battery is finally charged to SOC 100%. For example, when approximately 168 hours or more elapse, the accuracy of the SOC of the battery may be read as low.

ii) The accuracy of the SOC of the battery may be evaluated according to whether the number of times of partial charging (i.e., SOC 100% or less) exceeds a certain number of times rather than full charging after the battery is finally charged to 100%. For example, when approximately 14 days or more elapse, the accuracy of the SOC of the battery is read as low.

iii) Accuracy may be evaluated according to whether a certain period of time is exceeded after the battery is finally discharged to SOC 25% or less based on a final time point of the battery being discharged to SOC 25% or less. For example, when approximately 14 days or more elapse, accuracy of the SOH of the battery may be read as low.

iv) Based on the number of times of charging after the battery is finally discharged to 25% or less, the accuracy of the SOH of the battery may be read as low according to whether the number of times of charging exceeds the number of times of charging after the battery is finally discharged to SOC 25% or less.

Of course, when the cases i) to iv) do not apply, the accuracy of the SOC and/or the SOH of the battery are read as high.

Thereafter, the charging controller 220 and the charging station 120 may check whether the chargers installed in the charging controller 220 and the charging station 120, respectively, are chargers capable of supporting V2G (S520). In other words, the charger 240 provided in the vehicle 110 may be a one-way charger, or the charger installed in the charging station 120 may be a one-way charger. Therefore, a confirmation process is necessary. In other words, it is necessary to check whether the V2G function is possible by checking whether the charger is a one-way charger.

As a result of the confirmation in S520, when the chargers of the vehicle 110 and the charging station 120 are not chargers capable of supporting V2G, the charging controller 220 may receive power from the charging station 120 to perform charging of the vehicle 110 (S547). That is, when any one of the chargers of the vehicle 110 and the charging station 120 is a one-way charger, power is supplied in one-way manner from the charging station 120 to the charger 240. To this end, both the chargers of the vehicle 110 and the charging station 120 should be two-way chargers.

Otherwise, when the charger is capable of supporting V2G in S520, the charging controller 220 may check whether the battery status accuracy is low (S530).

When the battery status accuracy is low in S530, the charging controller 220 may check whether the vehicle driver consents to the use of V2G (S540). Of course, the consent may be achieved by the driver manipulating the input part 210 or may be set in the vehicle in advance. In other words, since the driver may only want to charge to 100%, this process saves a charging time by disabling the V2G function.

As a result of the check in S540, when there is the consent to use, the charging controller 220 may use V2G to sell power to battery SOC≤25% (S541). That is, after discharging to 25% or less and selling the power, charging is performed.

The management server 150 may accumulate the sold power as a power selling amount (S543).

Then, the charging controller 220 may calculate a current battery SOC and a current battery SOH (S545). The current battery SOC is calculated by integrating a current when the battery SOC is less than or equal to 25% and after the V2G function is executed.

In addition, the current battery SOH (i.e., a battery capacity) may be calculated as the total SOC when the battery is fully charged in an area where the battery SOC is less than or equal to 25%. In other words, when a designed nominal capacity of the battery 230 (i.e., an initial maximum capacity supplied by the manufacturer) is 2 Ah and the total SOC measured in the current state is 1 Ah, (1 Ah/2 Ah)*100%=50%. That is, the SOH may become 50%.

Since the current SOH may be calculated after the vehicle charging begins and full charging is achieved, the current battery SOH may also be calculated using a previously calculated battery SOH.

Of course, in order to check reliability and stability, it is also possible to measure a voltage deviation of the battery 230. That is, when the battery SOC falls to 25% or less, a voltage deviation between battery cells included in the battery 230 may be measured.

As the current battery SOC and the current battery SOH are calculated, charging of the vehicle 110 may be performed (S547).

Thereafter, the charging controller 220 may provide an estimated charging time to the driver and check whether to use the V2G function (S550). In other words, by providing the estimated charging time, the driver may determine whether to proceed with the charging. Of course, S550 may be performed before the charging (S547) or may be omitted.

As a result of the check in S550, when it is determined that the driver uses the V2G function, the management server 150 may deduct the power selling amount from the charging amount or accumulate the power selling amount (S560).

Otherwise, as the result of the check in S550, when it is determined that the driver does not use the V2G function, the process may be terminated.

Meanwhile, when the battery status accuracy is high in S530, the process proceeds to S547. In addition, when there is no user consent in S540, the process proceeds to S547.

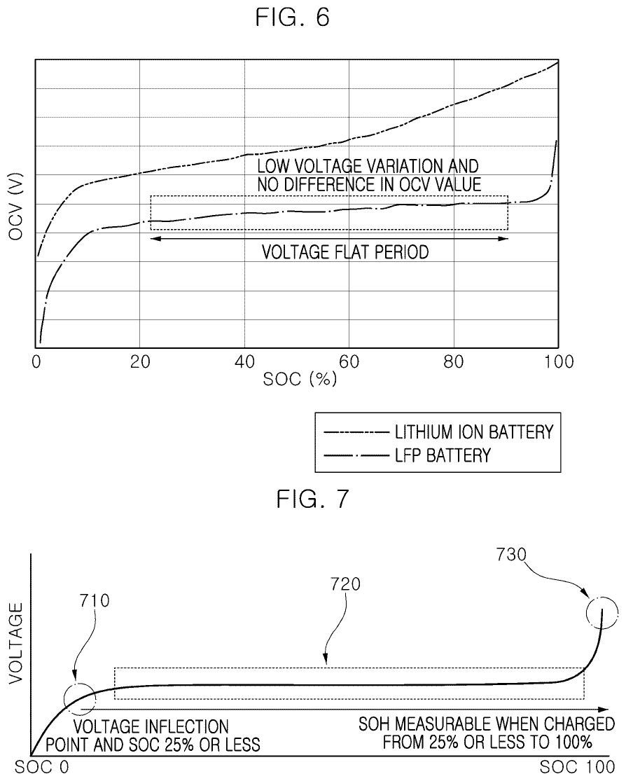

FIG. 6 is a graph showing a relationship between an SOC and an OCV of a general lithium ion battery and an LFP battery. That is, the graph is the SOC-OCV curve. Referring to FIG. 6, in the case of a lithium nickel cobalt manganese (NCM) voltage curve, even when the battery SOC exceeds 20%, the NCM voltage curve gradually increases to full charge (100%) without a voltage flat period.

In contrast, in the case of an LFP voltage curve, when the battery SOC is present in a period ranging from 25% to 99%, only a very low voltage variation may occur and there is almost no difference in OCV value. That is, a voltage flat period is present. Therefore, in the case of an LFP battery, when the SOC is present in the period ranging from 25% to 99%, the SOC may not be accurately measured using an OCV.

FIG. 7 is a graph showing an error cause of an amount of charging during general use. Referring to FIG. 7, when the voltage enters an inflection point 710, it is possible to measure a charging state through the OCV. In this case, the inflection point 710 may generally correspond to approximately the SOC 25%. In a flat period 720, an error in a remaining capacity may occur when the battery is used several times in the flat period 720. Due to the error, a mileage error may occur.

A full charging point 730 may refer to a point where the battery SOC is set to 100% when charging is performed to 100%. Of course, the full charging point 730 may be set differently for each manufacturer. It is possible to calculate the battery SOH using the inflection point 710 and the full charging point 730. That is, when the charging is performed from SOC 25% or less to 100%, the battery SOH is calculated.

In addition, the operations of the methods or algorithms described in connection with the embodiments disclosed herein may be implemented in the form of a program command which is executable through various computer means, such as a microprocessor, a processor, a central processing unit (CPU), and the like, and may be recorded in a computer-readable medium. The computer-readable medium may include program (command) codes, data files, data structures, and the like alone or a combination thereof.

According to embodiments of the present disclosure, when a vehicle to which a lithium iron phosphate (LFP) battery is applied is charged, an exact state of charge (SOC) and a state of health (SOH) of a battery may be easily calculated during charging by utilizing a vehicle to grid (V2G). Therefore, electricity may be sold to 24% of the SOC and electricity may be charged after calculating the SOC.

In addition, as another effect of embodiments of the present disclosure, battery performance improvement may be helped by calculating an exact SOC without affecting a usage pattern of a vehicle driver.

In addition, as still another effect of embodiments of the present disclosure, battery-related problems, such as rapid reduction in lifetime, may be detected in advance by measuring battery degradation so that a risk can be reduced.

In addition, as yet another effect of embodiments of the present disclosure, an estimated charging time may be accurately calculated.

While embodiments of the present disclosure have been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

What is claimed is:

1. A method of charging a battery of a vehicle using battery state diagnosis, the method comprising:
acquiring, by a charging controller, battery status information from the battery;
checking, by the charging controller, battery status accuracy using the battery status information;
according to the check result, determining, by the charging controller, whether to sell power stored in the vehicle; and
according to the determination result, discharging, by the charging controller, the power stored in the vehicle to a charging station or performing charging by receiving power from the charging station.

2. The method of claim 1, wherein checking the battery status accuracy comprises:
reading, by the charging controller, the battery status information in response to a state of charge (SOC) entering below a predetermined inflection point during discharging; and
according to the reading result, calculating, by the charging controller, the battery status accuracy.

3. The method of claim 1, wherein performing the charging comprises calculating, by the charging controller, a current battery state of charge (SOC) and a current battery state of health (SOH).

4. The method of claim 3, wherein the current battery SOC is calculated using a current integration during charging in a case in which the SOC during discharging of the battery is below a predetermined inflection point and a vehicle to grid function of supplying power to a power grid is executed.

5. The method of claim 3, wherein the current battery SOH is calculated using a total SOC at a time at which charging begins and the SOC during discharging of the battery is in an area from below a predetermined inflection point to a point at which the battery is fully charged.

6. The method of claim 1, wherein checking the battery status accuracy comprises:
checking whether the vehicle and the charging station are equipped with two-way chargers supporting a vehicle to grid function of supplying power to a power grid; and
according to the check result of whether the two-way chargers are provided, discharging the power stored in the vehicle to the charging station or performing charging by receiving the power from the charging station.

7. The method of claim 6, wherein, in response to the check result indicating the vehicle or the charging station is not equipped with the two-way charger, checking the battery status accuracy further comprises receiving, by the charging controller, the power from the charging station to perform charging.

8. The method of claim 1, wherein determining whether to sell the power comprises:
checking, by the charging controller, whether a driver consents to use a vehicle to grid function; and
according to the check result of whether the driver consents, determining whether to sell the power.

9. The method of claim 1, wherein the battery status information comprises a final date and time in which the battery is finally fully charged, a number of times the battery is partially charged after the battery is finally fully charged, a final discharging time point indicating a time point at which the battery is finally discharged below an inflection point, and a number of charging times of the battery after a final discharging indicating charging times after the battery is finally discharged below the inflection point.

10. The method of claim 9, wherein the battery comprises a lithium iron phosphate battery.

11. The method of claim 10, wherein the inflection point is a point at which the SOC becomes 25% on an SOC-OCV curve.

12. The method of claim 10, wherein the full charging is a position at which the SOC becomes 100% on the SOC-OCV curve.

13. An apparatus of charging a battery of a vehicle using battery state diagnosis, the apparatus comprising:
an input part configured to receive an input command of a user;
a charging controller configured to transmit and receive signals to and from components of the vehicle and control the components;
a battery for a power source to move the vehicle, the battery comprising a battery management system (BMS);
a charger comprising a two-way charger configured to convert an alternating current (AC) into a direct current (DC) to charge the battery or to convert the DC into the AC to provide the converted power to a power grid via a charging station; and
a communication part configured to connect the charging controller to a communication network, the charger, or the communication network and the charger.

14. The apparatus of claim 13, wherein the charging controller comprises:
a collection module configured to acquire battery status information;
a determination module configured to check battery status accuracy using the acquired battery status information and determine whether to sell the power and perform charging; and
a control module configured to control the charger for selling the power or charging.

15. The apparatus of claim 14, wherein the collection module is configured to acquire input information directly input by the user through the input part or acquire the battery status information from the BMS.

16. The apparatus of claim 14, wherein the determination module is configured to check accuracy of a current battery status using the battery status information acquired from the collection module, determine whether to sell the power stored in the vehicle, and perform charging.

17. The apparatus of claim 14, wherein the control module is configured to control the charger for power sales or charging.

18. The apparatus of claim 14, wherein the charging controller is configured to:
acquire the battery status information from the battery;
check battery status accuracy using the battery status information;
determine whether to sell power stored in the vehicle according to the check result of the battery status accuracy; and
discharge the power stored in the vehicle to the charging station or perform charging by receiving power from the charging station according to the determination result of whether to sell the power.

19. The apparatus of claim 18, wherein the charging controller is configured to calculate a current battery state of charge (SOC) and a current battery state of health (SOH).

20. The apparatus of claim 19, wherein:
the current battery SOC is calculated using a current integration during charging at a time at which the SOC during discharging of the battery is below a predetermined inflection point and a vehicle to grid function of supplying power to the power grid is executed; and
the current battery SOH is calculated using a total SOC at a time at which charging begins and the SOC during discharging of the battery is in an area from below the predetermined inflection point to a point at which the battery is fully charged.
